(19) United States
(12) Patent Application Publication
(10) Pub. No.: US 2006/0057342 A1
(43) Pub. Date: Mar. 16, 2006

(54) Laminated polyester film having controlled frictional coefficient

(76) Inventors: Soong Yoon, Anyang-si (KR); Sang-Il Kim, Suwon-si (KR); Yong-Won Kim, Suwon-si (KR)

Correspondence Address: David A. Einhom, Esq.;Anderson Kill & Olick, P.C., 1251 Avenue of the Americas, New York, NY, 10020, US

(21) Appl. No.: 11/114,570

(22) Filed: Apr. 25, 2005

(30) Foreign Application Priority Data
Sep. 10, 2004 (KR) 10-2004-0072566

(51) Int. Cl. B32B 7/02

(52) U.S. Cl. 428/212

(57) ABSTRACT

The present invention relates to a laminated polyester film comprising a first polyester resin layer having a static frictional coefficient of 0.6 to 4.5 and a second polyester resin layer having a static frictional coefficient lower than that of the first layer. The inventive laminated polyester film having a controlled static frictional coefficient is useful as a film for individual small-volume packaging.

### FIELD OF THE INVENTION

The present invention is directed to a laminated polyester film having a controlled frictional coefficient.

### BACKGROUND OF THE INVENTION

Polyester films have been used in various applications as packaging films due to their good physical, chemical and mechanical properties. In recent years, various products are distributed in small packages, and packaging films used therefor are required to have little slipperiness so that such small packages can be stacked high without collapsing. The slipperiness of the packaging film is directly related to its frictional coefficient which has been generally controlled by adding inorganic particles to the film-forming resin as disclosed in U.S. Pat. No. 6,068,909. However, the addition of inorganic particles adversely affect the resin properties, e.g., transparency, strength, processibility, etc.

### SUMMARY OF THE INVENTION

Accordingly, it is an object of the present invention to provide a polyester film having suitable frictional coefficient for use as a packaging film while maintaining its intrinsic properties such as good mechanical strength, dimension-stability, printability, optical property and processibility.

In accordance with the present invention, there is provided a laminated polyester film comprising a first polyester resin layer having a static frictional coefficient of 0.6 to 4.5 and a second polyester resin layer having a static frictional coefficient lower than that of the first layer.

### DETAILED DESCRIPTION OF THE INVENTION

The packaging polyester film according to the present invention is characterized in that it comprises a first polyester resin layer and a second polyester resin layer, and the surface of the first layer has a static frictional coefficient of 0.6 to 4.5 and the surface of the second layer has a static frictional coefficient lower than that of the first layer.

When the static frictional coefficient of the first layer is less than 0.6, packaged products is difficult to be stacked, and when it is greater than 4.5, the film processibility becomes poor. Also, it is preferred that the static frictional coefficient of the second layer is below 0.6 for the purpose of enhancing the film processibility.

The polyester resins which are used in each layer of the inventive film may be prepared by polycondensing an acid component such as terephthalic acid, isophthalic acid or naphthalene dicarboxylic acid with a polyhydric alcohol component such as ethylene glycol, trimethylene glycol, butylene glycol or cyclohexane dimethanol. It is preferred that the polyester resin has an intrinsic viscosity of 0.55 to 0.75 dl/g. When the intrinsic viscosity of each polyester resin is less than 0.55 dl/g, the mechanical strength of the film is poor, and when it is greater than 0.75 dl/g, the processibility of the film becomes poor.

In the present invention, inert inorganic particles are used to control the frictional coefficient of the first and second layers of the film. The inorganic particles should have a refractive index similar to that of the polyester resin used, little inner void for improving the transparence of the film, and good dispersibility for achieving good properties.

Examples of the inert inorganic particles include titanium dioxide, calcium carbonate, kaoline, barium sulfate, silica, talc, zeolite, etc, and among these, silica is most preferred. Also, it is desired that the inert inorganic particles have an average diameter of 0.1 to 6.5 μm and monodipersive spherical shapes.

According to the present invention, the first polyester resin layer contains said inert inorganic particles in an amount of 0.002 to 0.025% by weight to obtain the desired frictional coefficient of the inventive film and the second layer contains the inert inorganic particles in an amount of 0.025 to 3.5% by weight to confer good processibility and light transmittance of the film.

It is also desired that the thickness ratio of the first layer and the second layer ranges from 10:1 to 1:5 to obtain good film properties. The preferred thickness ratio is about 1:1.

The total thickness of the inventive film may vary depending on the type of products for packaging, and it is preferably about 12 to 19 μm.

The inventive laminated polyester film may be prepared by melt-extruding each polyester resin for forming the first and the second layers at a temperature higher than the melting point of the resin by about 30° C. using an extrusion die, laminating the extrudates in a feed block, cooling and biaxially drawing the laminate. It is desired that the cooling procedure is carried out by bringing the first polyester resin layer into contact with the surface of a cooling drum.

Also, since the surface characteristics of a film and other properties required for a packaging film depend on the drawing conditions such as drawing ratio and drawing temperature, in the present invention, the laminate of the first and second polyester resins is preferably drawn in the longitudinal direction at a draw ratio of 2 to 5 at a temperature ranging from 55 to 120° C. and in the transverse direction at a draw ratio of 2 to 5 at a temperature ranging from 100 to 160° C., so as to provide a film having a uniform thickness and a proper degree of crystallinity without defects. The biaxial drawing may be conducted simultaneously or successively.

The biaxially drawn film may be heat-set at a temperature ranging from 180 to 250° C. for 5 to 10 seconds to confer good thermal stability, crystallinity and strength and elongation at break of the film.

If necessary the polyester film according to the present invention may further comprise other components such as a thermal stabilizer, polycondensation catalyst, dispersant, electrostatic generator and antiblocking agent.

The present invention is further described and illustrated in Examples, which are, however, not intended to limit the scope of the present invention.

### EXAMPLE 1

A mixture of terephthalic acid and isophthalic acid in a weight ratio of 95:5 was mixed with ethylene glycol in an equivalent ratio of 1:2, and 0.02% by weight of antimony trioxide (a polymerization catalyst) and 0.01% by weight of silica having an average particle diameter of 2.0 μm were added thereto. The resulting mixture was polycondensed to obtain a first polyester resin having an intrinsic viscosity of 0.64 dl/g.

Separately, terephthalic acid was mixed with ethylene glycol in an equivalent ratio of 1:2, and 0.02% by weight of antimony trioxide (a polymerization catalyst) and 0.05% by weight of silica having an average particle diameter of 2.8 μm were added thereto. The resulting mixture was polycondensed to obtain a second polyester resin having an intrinsic viscosity of 0.62 dl/g.

The first and second polyester resins were each melt-extruded at 300° C., they were laminated together in a thickness ratio of 4:1 in a feed block, and the resulting laminate was cooled by passing through a cooling drum, to obtain an undrawn laminate sheet. The sheet was drawn at a ratio of 3.6 in the longitudinal direction (LD) at 95° C. and drawn at a ratio of 4.2 in the transverse direction (TD) at 125° C., and then heat-set at 230° C., to obtain a biaxially drawn, and laminated polyester film of 12 μm thickness.

### EXAMPLES 2 to 5 AND COMPARATIVE EXAMPLES 1 to 4

The procedure of Example 1 was repeated except that the amount of isophthalic acid used in the preparation of the first of polyester resin, the average particle diameter and amount of silica used in the preparation of each polyester resin and drawing ratios were varied as shown in Table 1.

The polyester films manufactured in Examples and Comparative Examples were evaluated for the following properties, and the results are listed in Table 1.

(1) Static Frictional Coefficient:

The static frictional coefficient of a sample film was calculated in accordance with the ASTM D1894 method by applying a load cell to a sample film and moving the load cell on the film to determine the frictional force between the load cell and the film.

(2) Thermal Shrinkage Ratio

A 15 mm (width)×300 mm (length) sample film was treated in hot oven (150° C.) for 30 minutes, and its length was measured to determine the thermal shrinkage ratio in the longitudinal direction.

(3) Light Transmittance

The light transmittance of a sample film was measured in accordance with the ASTM D1003 method (diameter: 25 mm, scattering angle: 2.5°).

(4) Haze

The haze of a sample film was measured using a haze tester (Model xl-211, manufactured by Gardner Neotech.).

TABLE 1

| | | | | Second PET resin | | | | Properties of the film | | | | |
|---|---|---|---|---|---|---|---|---|---|---|---|---|
| | First PET resin layer | | | layer | | | | | Static | | | |
| | Isophthalic | Silica | | Silica | | | | Static | frictional | Thermal | | |
| | acid | Average | | Average | | | | frictional | coefficient of | shrinkage | | |
| Ex. | amount | diameter | Amount | diameter | Amount | Draw ratio | | coefficient of | the second | ratio | Light | Haze |
| No. | (wt %) | (μm) | (wt %) | (μm) | (wt %) | LD | TD | the first layer | layer | (LD/TD) | transmittance (%) | (%) |
| 1 | 5 | 2.0 | 0.01 | 2.8 | 0.05 | 3.6 | 4.2 | 1.2 | 0.45 | 2.0/1.0 | 92 | 1.5 |
| 2 | 0 | 2.5 | 0.015 | 2.8 | 0.07 | 4.2 | 4.0 | 0.85 | 0.45 | 0.5/0.8 | 91 | 1.7 |
| 3 | 3 | 2.0 | 0.007 | 2.5 | 0.05 | 3.6 | 4.0 | 2.5 | 0.45 | 1.5/0.8 | 93 | 1.4 |
| 4 | 0 | 2.8 | 0.015 | 1.5 | 0.1 | 4.0 | 4.0 | 0.70 | 0.42 | 0.7/0.7 | 90 | 4.2 |
| 5 | 0 | 3.5 | 0.007 | 4.2 | 0.05 | 3.6 | 4.0 | 2.5 | 0.45 | 1.5/0.7 | 92 | 1.6 |
| Com. | 0 | 2.8 | 0.000 | 2.5 | 0.07 | 3.6 | 4.2 | — | — | 1.8/0.5 | 91 | 1.7 |
| Ex. 1 | | | | | | | | | | | | |
| Com. | 0 | 0.5 | 0.03 | 2.5 | 0.05 | 4.0 | 4.0 | 0.55 | — | 1.7/0.4 | 92 | 2.2 |
| Ex. 2 | | | | | | | | | | | | |
| Com. | 5 | 7.2 | 0.01 | 1.5 | 0.1 | 3.0 | 4.0 | 0.45 | — | 2.2/0.8 | 89 | 4.3 |
| Ex. 3 | | | | | | | | | | | | |
| Com. | 0 | 2.8 | 0.001 | 2.5 | 0.07 | 3.6 | 4.2 | — | — | 1.5/0.6 | 92 | 1.7 |
| Ex. 4 | | | | | | | | | | | | |

As can be shown in Table 1, the films of Examples 1 to 5 showed satisfactory properties in terms of static frictional coefficient, thermal shrinkage ratio, light transmittance and haze, while the films of Comparative Examples 1 to 4 were evaluated to be poor in terms of static frictional coefficient.

While the invention has been described with respect to the above specific embodiments, it should be recognized that various modifications and changes may be made to the invention by those skilled in the art which also fall within the scope of the invention as defined by the appended claims.

What is claimed is:

1. A laminated polyester film comprising a first polyester resin layer having a static frictional coefficient of 0.6 to 4.5 and a second polyester resin layer having a static surface frictional coefficient lower than that of the first layer.

2. The laminated polyester film of claim 1, wherein the second polyester resin layer has a static frictional coefficient of below 0.6.

3. The laminated polyester film of claim 1, wherein the first layer contains inert inorganic particles having an average particle diameter of 0.1 to 6.5 μm in an amount of 0.002 to 0.025% by weight and the second layer contains inert inorganic particles having an average particle diameter of 0.1 to 6.5 μm in an amount of 0.025 to 3.5% by weight.

4. The laminated polyester film of claim 3, wherein the inert inorganic particles are at least one selected from the group consisting of titanium dioxide, calcium carbonate, kaoline, barium sulfate, silica, talc and zeolite.

5. The laminated polyester film of claim 4, wherein the inert inorganic particles have monodipersive spherical shapes.

6. The laminated polyester film of claim 1, wherein the first layer and the second layer have a thickness ratio of 10:1 to 1:5.

7. The laminated polyester film of claim 1, wherein the first layer and the second layer comprise polyester resins prepared by polycondensing terephthalic acid, isophthalic acid or naphthalene dicarboxylic acid as an acid component with ethylene glycol, trimethylene glycol, butylene glycol or cyclohexane dimethanol as a polyhydric alcohol component.
